(19) United States
(12) Patent Application Publication
(10) Pub. No.: US 2026/0226788 A1
(43) Pub. Date: Aug. 6, 2026

(54) DOOR AND DOOR JAMB ASSEMBLY

(71) Applicant: Nima Naderi, Maple (CA)

(72) Inventor: Nima Naderi, Maple (CA)

(21) Appl. No.: 19/263,801

(22) Filed: Jul. 9, 2025

Related U.S. Application Data
(60) Provisional application No. 63/755,072, filed on Feb. 6, 2025.

(51) Int. Cl. E06B 1/16; E06B 3/70; E06B 3/82

(52) U.S. Cl. CPC E06B 3/82; E06B 1/16; E06B 1/52; E06B 3/2605; E06B 3/725; E06B 3/822; E06B 2003/7074

(57) ABSTRACT

A door assembly is provided including a door slab member and a door jamb member. The door slab member is configured to extend along a bottom side, a first side, a top side, and a second side perimeter of a door. The door jamb member is configured to extend along a first side, a top side, and a second side perimeter of a doorway wall. The door slab member is attached to the door jamb member via at least one hinge joint positioned at the second side perimeter of the door and the second side perimeter of the doorway wall.

### FIELD OF THE INVENTION

The present embodiments described in this specification relate generally to a door and door jamb system or assembly. More specifically, the embodiments relate to an improved flush interior door system for minimalistic design and ease of installation.

### BACKGROUND OF THE INVENTION

Doors and their accompanying jamb systems play a critical role in both residential and commercial buildings, serving as primary access points while also contributing to security, energy efficiency, and aesthetics. However, traditional door and door jamb systems often present various design and construction challenges that can affect their performance and longevity. These issues range from material deficiencies to improper installation techniques, impacting functionality, durability, and overall user satisfaction.

One of the primary concerns with traditional door and jamb systems is the choice of materials. Many doors and jambs are constructed from wood, which, despite its aesthetic appeal and ease of customization, comes with several drawbacks. For example, wooden doors and jambs can absorb moisture, leading to warping, swelling, and rot. This is especially problematic in humid climates or areas exposed to frequent rainfall. In addition, wood is vulnerable to termites and other pests, which can weaken the structural integrity of the door and jamb over time. Traditional materials can suffer from cracking, splitting, or denting due to regular use, requiring frequent maintenance or replacement.

Traditional door jambs often lack the structural reinforcement necessary to withstand forceful entry attempts, making them a weak point in home and building security. Standard strike plates, which hold the latch and deadbolt in place, may not be securely anchored to the framing, making them easy to force open. Many door jambs are constructed from lightweight materials and may not be securely fastened to the surrounding framing, reducing their ability to withstand impacts or stress. Standard hinges can become loose over time, especially if not properly reinforced, leading to sagging doors and misalignment issues that compromise both security and functionality.

Proper installation is critical for doors and jambs to function effectively, but traditional systems present several challenges such as improper framing and leveling, expansion and contraction issues, and shimming difficulties. For example, if the door frame is not properly squared and leveled during installation, it can result in doors that do not close properly or that stick, making them difficult to operate. Wooden doors expand and contract with temperature and humidity changes, which can lead to misalignment over time. In addition, during installation, shims are used to ensure proper fit, but incorrect placement or excessive use can lead to instability or an uneven door operation.

Accordingly, there is a need for an improved flush interior door system that addresses the abovementioned issues with doorway design, construction, and installation.

### SUMMARY OF THE INVENTION

A door assembly is provided including a door slab member and a door jamb member. The door slab member is configured to extend along a bottom side, a first side, a top side, and a second side perimeter of a door. The door jamb member is configured to extend along a first side, a top side, and a second side perimeter of a doorway wall. The door slab member is attached to the door jamb member via at least one hinge joint positioned at the second side perimeter of the door and the second side perimeter of the doorway wall.

These and other features and advantages will become apparent from the following detailed description of the presently preferred embodiment(s), taken in conjunction with the accompanying drawings.

### BRIEF DESCRIPTION OF THE DRAWINGS

The drawings reference herein forms a part of the specification. Features shown in the drawings are meant as illustrative of only some embodiments, and not of all embodiments unless otherwise explicitly indicated.

FIG. 1 depicts a front perspective view of a door assembly, in accordance with an embodiment of the invention.

FIG. 2 depicts a top view of a horizontal cross-section of a door assembly at line A-A of FIG. 1, in accordance with an embodiment of the invention.

FIG. 3 depicts a focused top view of a horizontal cross-section of a door assembly at line A-A of FIG. 1, in accordance with an embodiment of the invention.

FIG. 4 depicts a focused top view of a horizontal cross-section of a door assembly at line A-A of FIG. 1, in accordance with an embodiment of the invention.

FIG. 5 depicts a perspective view of a door assembly with the door opened, revealing two hinge joints, in accordance with an embodiment of the invention.

FIG. 6 depicts a top perspective view of a door assembly with the door opened, in accordance with an embodiment of the invention.

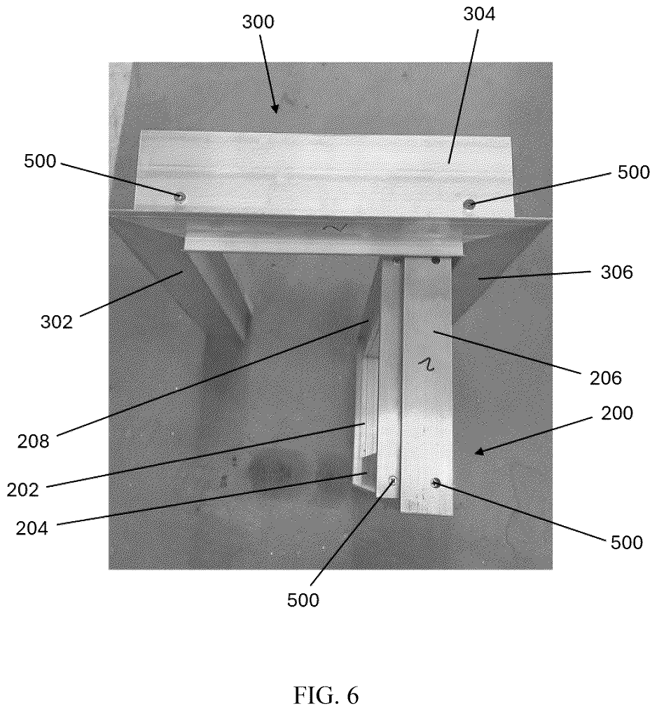

FIG. 7 depicts a focused top view of a horizontal cross-section of a door assembly at line A-A of FIG. 1, in accordance with an embodiment of the invention.

FIG. 8 depicts a focused top view of a horizontal cross-section of a door assembly at line A-A of FIG. 1, in accordance with an embodiment of the invention.

FIG. 9 depicts a focused top view of a horizontal cross-section of a door assembly at line A-A of FIG. 1, in accordance with an embodiment of the invention.

FIG. 10 depicts a focused top view of a horizontal cross-section of a door assembly at line A-A of FIG. 1, in accordance with an embodiment of the invention.

FIG. 11 depicts a focused top view of a horizontal cross-section of a door assembly at line A-A of FIG. 1, in accordance with an embodiment of the invention.

FIG. 12 depicts a front perspective view of a baseboard assembly, in accordance with an embodiment of the invention.

FIG. 13 depicts a side view of a vertical cross-section of a baseboard edge member at line B-B of FIG. 12, in accordance with an embodiment of the invention.

### DETAILED DESCRIPTION OF EMBODIMENTS OF THE INVENTION

It will be readily understood that the components of the present embodiment(s), as generally described and illustrated in the Figures herein, may be arranged and designed in a wide variety of different configurations. Thus, the following detailed description of the embodiments of the apparatus, system, and method of the present embodiment(s), as presented in the Figures, is not intended to limit the scope of the embodiment(s), as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment described herein. Thus, appearances of the phrases “a select embodiment,” “in one embodiment,” or “in an embodiment” in various places throughout this specification are not necessarily referring to the same embodiment.

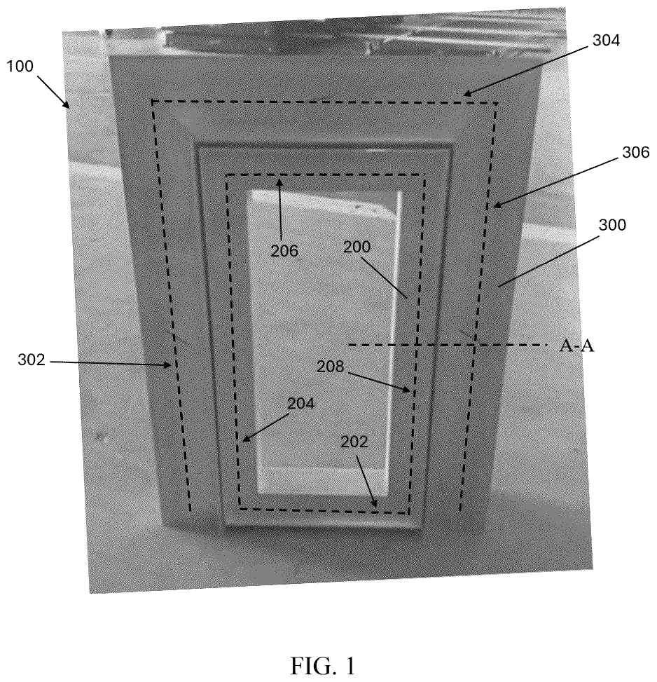

As shown in FIGS. 1, 2, 4 and 5, an embodiment of a door assembly 100 includes a door slab member 200 and a door jamb member 300. The door slab member 200 is configured to extend along a bottom side perimeter 202, a first side perimeter 204, a top side perimeter 206, and a second side perimeter 208 of a door 110. The door jamb member 300 is configured to extend along a first side perimeter 302, a top side perimeter 304, and a second side perimeter 306 of a doorway wall 120. The door slab member 200 is attached to the door jamb member 300 via at least one hinge joint 400 positioned at the second side perimeter 208 of the door 110 and the second side perimeter 306 of the doorway wall 120. In an alternative embodiment, the at least one hinge joint 400 is positioned at the first side perimeter 204 of the door 110 and the first side perimeter 302 of the doorway wall 120.

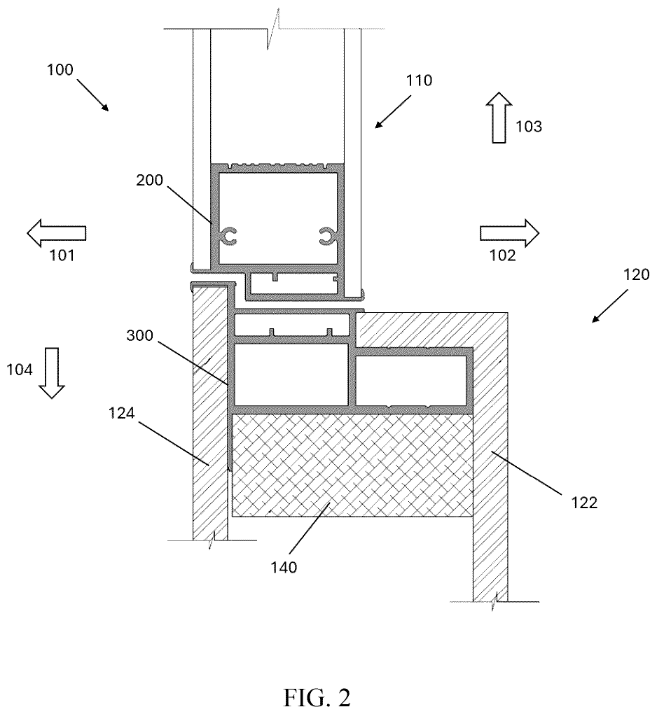

The door assembly 100 is configured to be positioned in a doorway and has a minimal visual footprint from either side of the doorway. As can be seen in FIG. 2, the door slab member 200 is embedded into a door 110, and the door jamb member 300 is embedded into a doorway wall 120.

The term “body,” as used herein, defines a structural portion of the cross-section of a member that is enclosed on all four sides of the planar cross-section. As such, each “body” includes at least three walls defining a corresponding interior hollow space. Adjacent or adjoining bodies may share a wall, which may be considered to be part of both bodies.

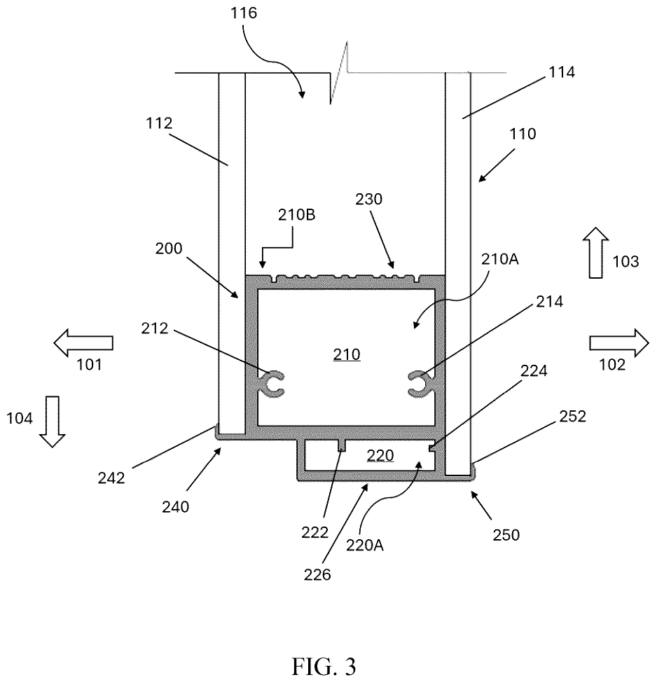

As shown in further detail in FIG. 3, an embodiment of the door slab member 200 has a cross-section including a hollow, rectangular primary slab body 210, and a hollow, rectangular secondary slab body 220 extending from an exterior side (the side of the secondary slab body 220 towards the exterior direction) of the door slab member 200. The primary slab body 210 of the cross-section of the door slab member 200 includes at least two C-shaped protrusions 212, 214 within an interior hollow space 210A of the primary slab body 210. The C-shaped protrusions 212 and 214 are used to screw a top and bottom of interior aluminum pieces together. The secondary slab body 220 of the cross-section of the door slab member 200 includes at least two protrusions 222, 224 within an interior hollow space 220A of the secondary slab body 220.

An embodiment of the door slab member 200 may have a cross-section further including a first slab lip 240 extending in a first direction 101 from the primary slab body 210 and a second slab lip 250 extending in a second direction 102 from the secondary slab body 220. The first slab lip 240 may have an L-shape with a distal end 242 extending in an interior direction 103. The second slab lip 250 may have an L-shape with a distal end 252 extending in the interior direction 103.

Yet another embodiment of the door slab member 200 may have a cross-section further including a plurality of recesses 230 on an interior side 210B of the primary slab body 210. The recesses 230 serve as a cavity for collecting excess glue during the bonding of interior board panels.

As mentioned above, the door slab member 200 is embedded into a door 110. Specifically, the door slab member 200 is positioned between a first door panel 112 and a second door panel 114. A space 116 is created between the first door panel 112 and the second door panel 114 and towards the interior direction 103 from the door slab member 200. In an embodiment, the space 116 is empty, while in an alternative embodiment, the space 116 is filled with a solid material such as wood, foam, plastic, metal structural components, etc. The first door panel 112 is cupped by the first slab lip 240 such that it is held in place by the distal end 242 of the first slab lip 240 against the door slab member 200 on a first side. The second door panel 114 is cupped by the second slab lip 250 such that it is held in place by the distal end 252 against the door slab member 200 on a second side. In doing so, the visual footprint of the door slab member 200 is minimized as the only portions of the door slab member 200 seen on either side of the door 110 when it is closed is the profile of the distal end 242 of the first slab lip 240 on one side of the door 110 and the distal end 252 of the second slab lip 250 on the other side of the door 110.

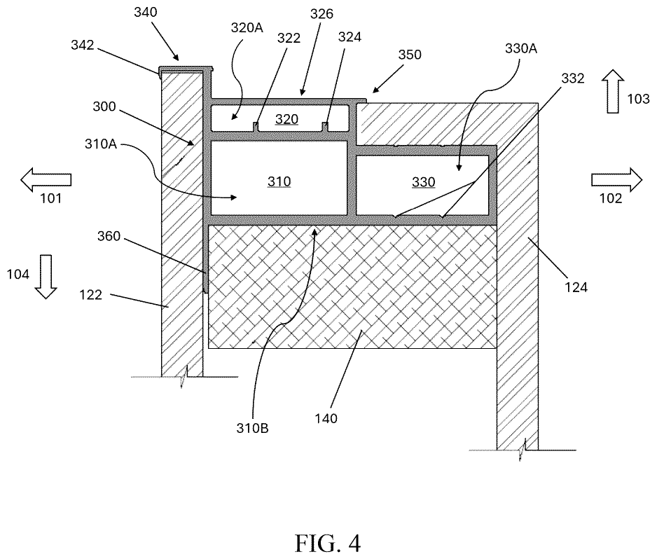

As shown in further detail in FIG. 4, an embodiment of the door jamb member 300 has a cross-section including a hollow, rectangular primary jamb body 310 and a hollow, rectangular secondary jamb body 320 extending in the interior direction 103 from the primary jamb body 310, and a hollow, rectangular tertiary jamb body 330 extending in the second direction 102 from the primary jamb body 310. The primary jamb body 310 has an interior hollow space 310A.

In an embodiment of the invention, the secondary jamb body 320 of the door jamb member 300 includes at least two protrusions 322, 324 within an interior hollow space 320A of the secondary jamb body 320. The tertiary jamb body 330 of the door jamb member 300 includes at least two recesses 332 within an interior hollow space 330A of the tertiary jamb body 330.

The door jamb member 300 may have a cross-section further including a first jamb lip 340 extending in an interior direction 103 from the secondary jamb body 320. The first jamb lip 340 may have a U-shape with a distal end 342 extending in an exterior direction 104. A second jamb lip 350 extends in a second direction 102 from the secondary jamb body 320. The door jamb member 300 may further have a support lip 360 extending in an exterior direction 104 from an exterior side 310B of the primary jamb body 310.

As mentioned above, the door jamb member 300 is embedded into a doorway wall 120. Specifically, the door jamb member 300 is affixed to a stud 140 within the doorway wall 120 and is positioned between a first wall panel 122 and a second wall panel 124. The support lip 360 provides added leverage for the door jamb member 300 against the stud 140 as the support lip 360 allows for the door jamb member 300 to ‘wrap around’ the stud 140 at an edge of the stud 140. The first wall panel 122 is cupped by the first jamb lip 340 such that it is held in place by the distal end 342 of the first jamb lip 340 against the door jamb member 300 on a first side. The second wall panel 124 is cupped by the second jamb lip 350 such that it is held in place against the secondary jamb body 320 and around the tertiary jamb body 330. In doing so, the visual footprint of the door jamb member 300 is minimized as the only portions of the door jamb member 300 seen on either side of the door 110 when it is closed is the profile of the distal end 342 of the first jamb lip 340 on one side of the door 110 and the edge of the second jamb lip 350 on the other side of the door 110.

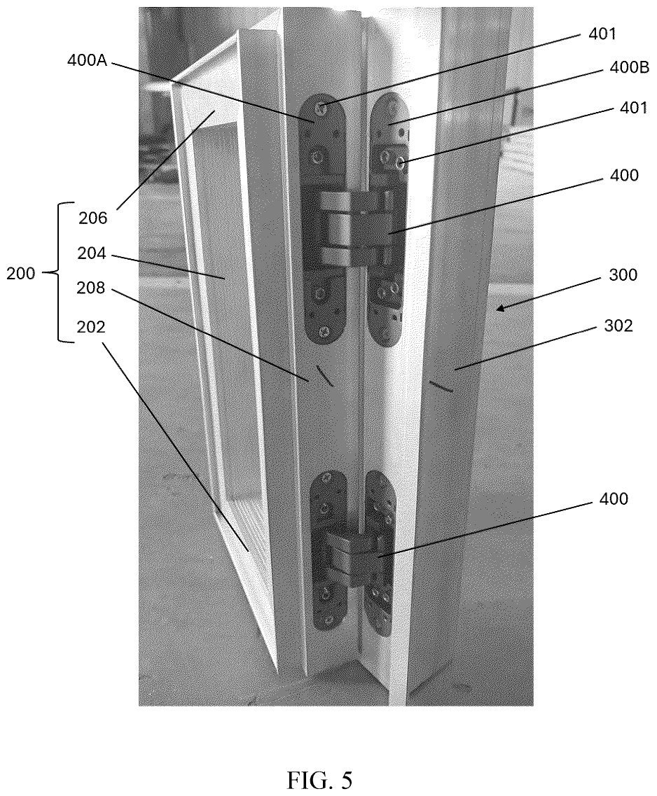

As shown in FIG. 5, hinges 400 may be embedded into the door slab member 200 and door jamb member 300 to minimize the visual footprint of the hinges 400. Specifically, apertures may be made into the door slab member 200 and door jamb member 300 to receive first and second sides (400A and 400B, respectively) of a hinge 400. Fasteners 401, such as bolts and/or screws, may be used to fasten the hinges 400 onto the door slab member 200 and door jamb member 300. In an embodiment, apertures are made into the door slab faceplate 226 and the door jamb faceplate 326 so that the first side 400A of a hinge 400 may be positioned within the hollow space 220A of the secondary slab body 220 and the second side 400B of the hinge 400 may be positioned within the hollow space 320B of the secondary jamb body 320. Within the door slab member 200, fasteners 401 are configured to engage threaded holes (not shown) on a wall shared between the primary slab body 210 and the secondary slab body 220 as well as engage the at least two protrusions 222, 224. Within the door jamb member 300, fasteners 401 are configured to engage threaded holes (not shown) on a wall shared between the primary jamb body 310 and the secondary jamb body 320 as well as engage the at least two protrusions 322, 324.

Extruded sections of the door slab member 200 and door jamb member 300 (i.e., the bottom side perimeter 202, first side perimeter 204, top side perimeter 206, and second side perimeter 208 of the door slab member 200, as well as the first side perimeter 302, top side perimeter 304, and second side perimeter 306 of the door jamb member 300) may be joined together by various means. In one embodiment, the extruded sections of each of the door slab member 200 and door jamb member 300 are joined by fasteners 500 such as bolts and/or screws. In an alternative embodiment, the extruded sections of each of the door slab member 200 and door jamb member 300 are joined by adhesives or are welded together.

Moreover, the first door panel 112 and the second door panel 114 abut the door slab member 200 on either side while the first wall panel 122 and the second wall panel 124 abut the door jamb member 300 on either side. In one embodiment, the first door panel 112 and the second door panel 114 are held in place without the use of fasteners or adhesives. In alternative embodiments, the first door panel 112 and the second door panel 114 are held in place by being fastened to the door slab member 200 with fasteners or otherwise affixed to the door slab member 200 by adhesives. Similarly, in an embodiment, the first wall panel 122 and the second wall panel 124 are held in place without the use of fasteners or adhesives. In alternative embodiments, the first wall panel 122 and the second wall panel 124 are held in place by being fastened to the door jamb member 300 with fasteners or otherwise affixed to the door jamb member 300 by adhesives.

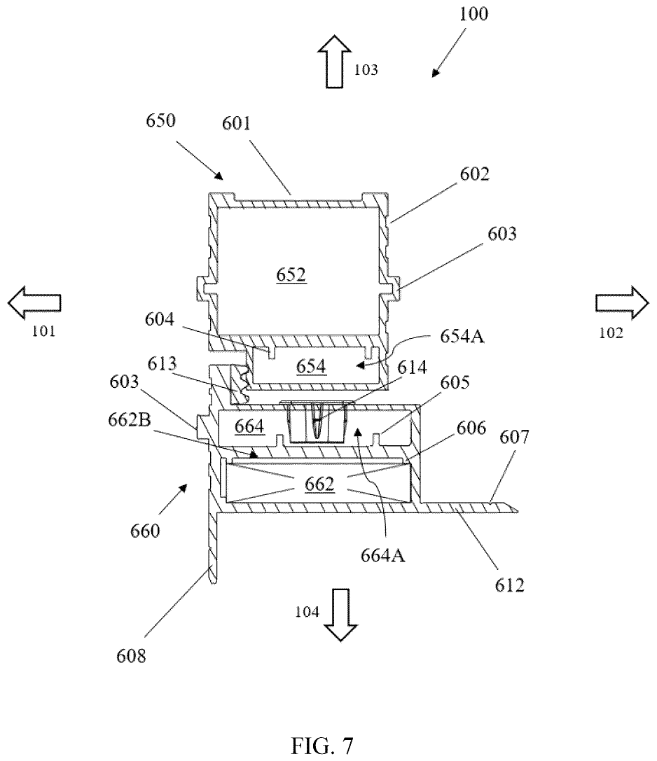

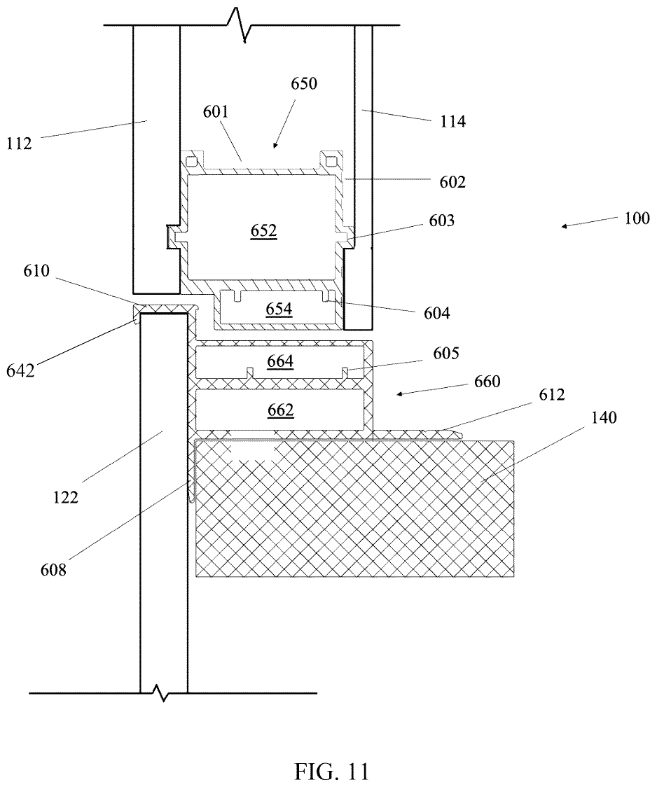

In an alternative embodiment, a door assembly 100 comprises a door slab member 650 and a door jamb member 660, as shown in FIGS. 7 to 11. As shown in FIG. 7, at least one bump 603 extending in a second direction 102 and at least one bump 603 extending in a first direction 101 may be configured along the primary slab body 652 to fit with corresponding grooves in the first door panel 112 and the second door panel 114, locking the assembly square and tight without the need for shims or back-blocking. At least one bump 603 extending in a first direction 101 may be configured on the door jamb member 660 in order to fit with corresponding grooves in a first wall panel 122. In one embodiment, an adhesive glue is applied between the door assembly 100 and the doorway wall 120 to affix the door assembly 100 to the doorway wall 120, and small fluctuations 602 collect excess adhesive glue between the board and the frame during assembly. This assembly creates a door surface with no visible recess and eliminates the need for a drywall lip.

As shown in FIGS. 7 to 10, a door lock 614 is configured between the door jamb member 660 and the door slab member 650. The door lock 614 extends into the interior space of the secondary jamb body 664. Further, a rubber insert 613 is configured between the door jamb member 660 and the door slab member 650 in order to reduce noise during door opening and closing.

Further, as shown in FIGS. 7 to 11, there is configured a recess 601 on the interior direction 103 of the primary slab body 652 in order to provide additional support within the door assembly 100. Further, the door jamb member 660 may have a first support lip 608 extending in an exterior direction 104 from the primary jamb body 662. The door jamb member 660 may also have a second support lip 612, extending in a second direction 102 from the primary jamb body 662. Both the first support lip 608 and the second support lip 612 function to allow them to be grooved into a stud 140. Screw holes 607 are provided along the surfaces of the first support lip 608 and second support lip 612, configured to secure the frame to wall studs. A depth control recess 605 is also provided, extending into the secondary door jamb member interior space 664A. These depth control recesses 605 allow for hinge cut-out machining. An adjustment pocket 604 is provided which extends into the secondary slab member interior space 654A. These adjustment pockets allow for precise hinge positioning. Further, a slot 606 may be included on the interior edge 662B of the primary jamb member 662, configured to fit a universal corner connector.

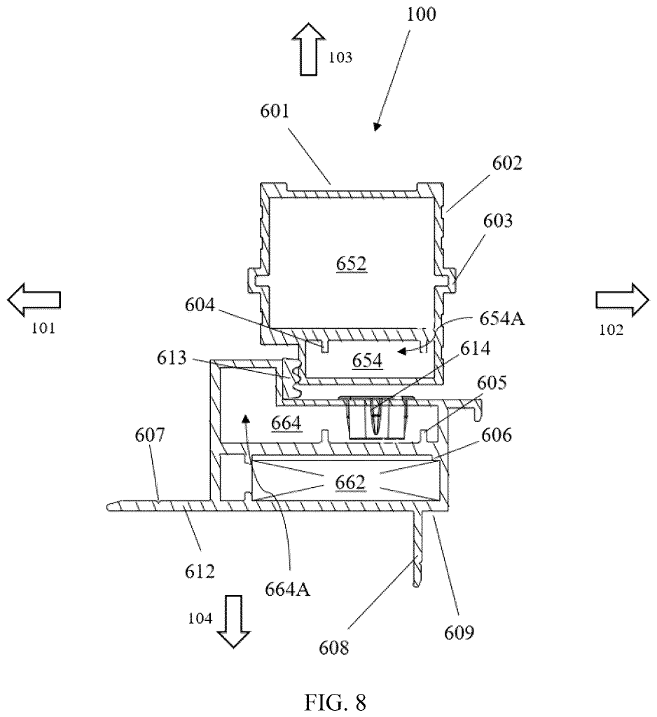

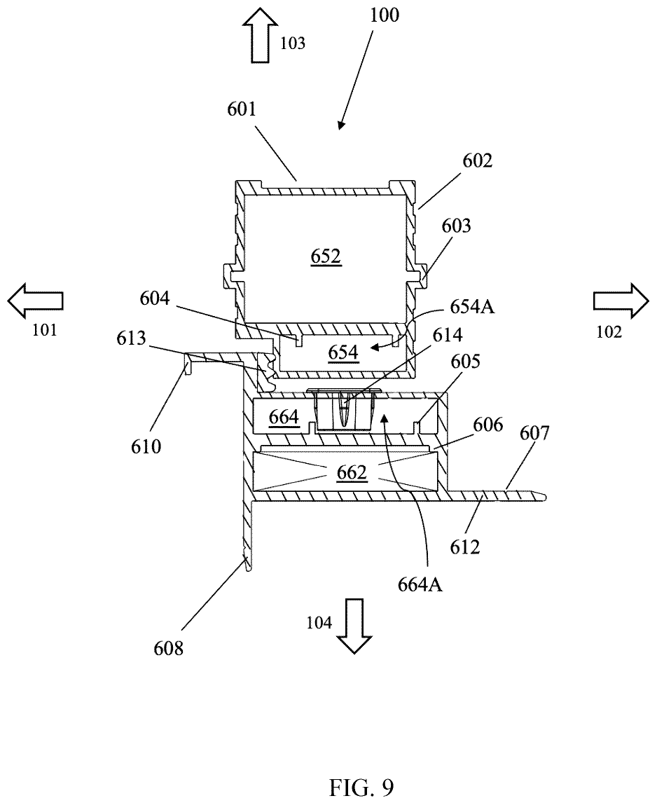

As shown in FIG. 7, the door jamb member 660 may utilize at least one bump 603 to fit with corresponding grooves in a first wall panel 122 instead of utilizing an L-shaped lip 610. As shown in FIG. 8, a mirrored embodiment of a door assembly 100 may be configured to allow the door to open in the opposite direction (i.e., outward instead of inward). As shown in FIG. 9, an embodiment of the invention may utilize both at least one bump 603 on the door slab member 650 and an L-shaped lip 610 extending from the first side of the door jamb member 660, as shown in FIG. 9, to affix the door assembly 100 to the doorway wall 120. The first wall panel 122 is cupped by the L-shaped lip 610 such that it is held in place by the distal end 642 of the L-shaped lip 610 against the door jamb member 660 on a first side. This L-shaped lip 610 provides an aluminum edge protector for drywall termination.

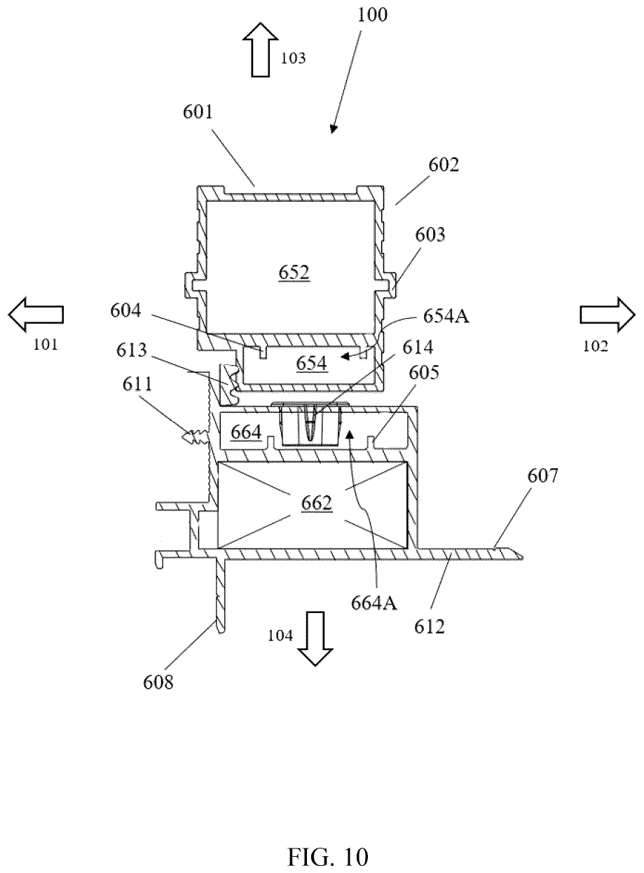

In an embodiment, as shown in FIG. 10, the door assembly 100 may also have a grooved protrusion 611 extending from a first side of the door jamb member 660. The grooved protrusion 611 ensures correct alignment of internal wood components and may conceal a channel within the assembly that accepts a thin casing. The casing may be a decorative overlay (e.g., wood veneer, porcelain slab, laminate, stone, etc.), which expands the design possibilities of the assembly while maintaining the appearance of no visible recess.

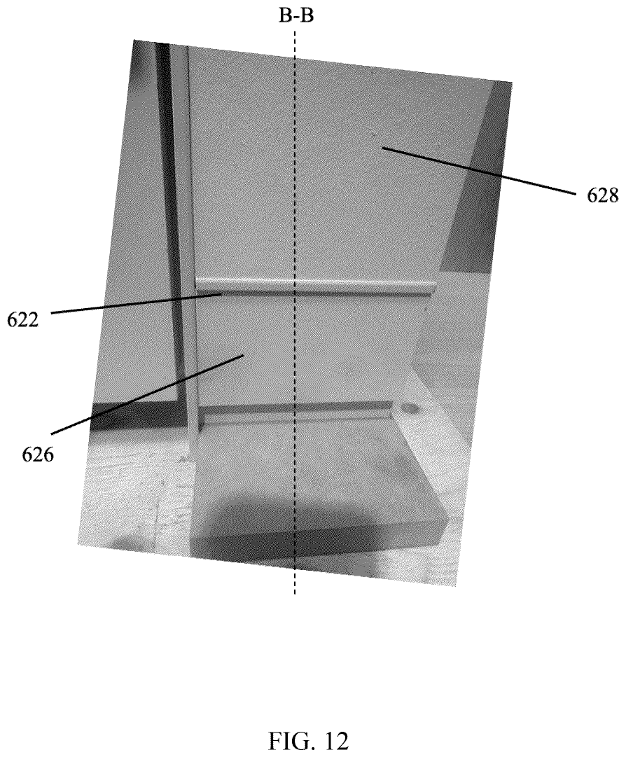

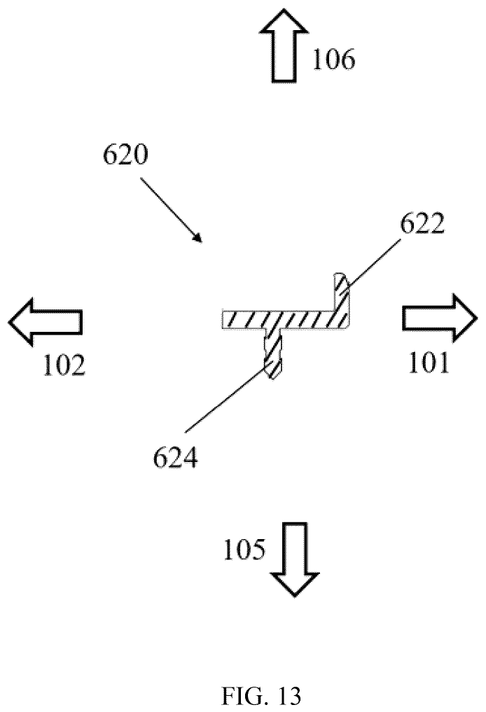

In an embodiment, as shown in FIGS. 12 and 13, the bottom of a drywall panel 628 is configured with a baseboard edge member 620, with a baseboard lip 622 extending in an upward direction 106 to hide and protect the bottom of the drywall panel 628. The baseboard edge member 620 is further configured with a grooved protrusion 624, extending in a downward direction 105 to make a flush fit with a baseboard member 626 via a complimentary groove in the baseboard member 626.

The aforementioned embodiments provide improvements over traditional doors by accommodating a drywall edge directly. By accommodating the edge of a drywall panel 628, the present invention eliminates the need for traditional finishing techniques—such as taping or sanding—used in traditional assemblies, thereby saving time and money during manufacturing. The frameless door system simplifies the installation process and eliminates the need for additional materials like casing, reducing labour costs. By eliminating the need for traditional finishing, the door system also mitigates the risk of cracking at the joint between the door frame and drywall, which is a common problem in conventional installations. Furthermore, the present embodiments offer robust protection for the drywall edge, preventing chipping and wear over time. The stability of the overall door assembly is also maintained through a flush alignment with the wall surface, enhancing structural stability and increasing the speed of on-site installation.

Further, the present embodiments provide advantages over other flush door designs by eliminating the need for taping, plastering, and sanding, which reduces costs and labour time involved in assembly. The described embodiments also provide flexibility in terms of materials and design options (e.g., aluminum or wood), beyond those provided in current flush door design options.

Moreover, the described embodiments of the present invention broaden aesthetic and functional options while maintaining the same frameless principles. For instance, the bump and groove embodiment creates an uninterrupted, minimal assembly façade with no visible recess. Traditional doors often feature visible trims and moldings which can detract from the aesthetic design of a space. The frameless, bump and groove embodiment offers a sleek and minimalist appearance with no visible casing that creates a clean transition between the door and the wall. Another embodiment allows for a designer overlay variant for projects that require subtle accents or contrasting materials, maintaining a frameless appearance while expanding design possibilities. Last, the aforementioned assembly embodiments may be mirrored, enabling doors to open into either a corridor or a room, without altering performance characteristics.

The embodiments of the present invention are ideal for residential, commercial, and office settings where a clean and modern look is desired. The reduced installation complexity makes it especially suitable for projects with tight timelines or limited budgets, without compromising on quality or aesthetics. The described embodiments of the frameless interior door system offer an innovative solution to common problems associated with traditional door installations. By simplifying the installation process, reducing material use, and enhancing the overall aesthetic, this design represents a significant advancement in interior door technology.

Various embodiments of the invention have been described in detail. Since changes in and or additions to the above-described best mode may be made without departing from the scope of the invention, the invention is not to be limited to those details but only by the appended claims. Section headings herein are provided as organizational cues. These headings shall not limit or characterize the invention set out in the appended claims.

What is claimed is:

1. A door assembly comprising:
a door slab member configured to extend along a bottom side, a first side, a top side, and a second side perimeter of a door; and
a door jamb member configured to extend along a first side, a top side, and a second side perimeter of a doorway wall,
wherein the door slab member is attached to the door jamb member via at least one hinge joint positioned at the second side perimeter of the door and the second side perimeter of the doorway wall.

2. The door assembly of claim 1, wherein the door slab member has a cross-section including:
a hollow, rectangular primary slab body; and
a hollow, rectangular secondary slab body extending from an exterior side of the door slab member.

3. The door assembly of claim 2, wherein the primary slab body of the cross-section of the door slab member includes at least two C-shaped protrusions within an interior hollow space of the primary slab body.

4. The door assembly of claim 3, wherein the secondary slab body of the door slab member includes at least two protrusions within an interior hollow space of the secondary slab body.

5. The door assembly of claim 2, wherein the door slab member has a cross-section further including:
a first slab lip extending in a first direction from the primary slab body, the first lip having an L-shape with a distal end extending in an interior direction; and
a second slab lip extending in a second direction from the secondary slab body, the second lip having an L-shape with a distal end extending in the interior direction.

6. The door assembly of claim 2, wherein the door slab member has a cross-section further including a plurality of recesses on an interior side of the primary slab body.

7. The door assembly of claim 1, wherein the door jamb member has a cross-section including:
a hollow, rectangular primary jamb body;
a hollow, rectangular secondary jamb body extending from an interior side of the primary jamb body; and
a hollow, rectangular tertiary jamb body extending from a second side of the primary jamb body.

8. The door assembly of claim 7, wherein the secondary jamb body of the door jamb member includes at least two protrusions within an interior hollow space of the secondary jamb body.

9. The door assembly of claim 8, wherein the tertiary jamb body of the door jamb member includes at least two recesses within an interior hollow space of the tertiary jamb body.

10. The door assembly of claim 7, wherein the door jamb member has a cross-section further including:
a first jamb lip extending in an interior direction from the secondary jamb body, the first lip having a U-shape with a distal end extending in an exterior direction; and
a second jamb lip extending in a second direction from the secondary jamb body.

11. The door assembly of claim 7, wherein the door jamb member has a cross-section further including a support lip extending in an exterior direction from an exterior side of the primary jamb body.

12. The door assembly of claim 2, wherein the door jamb member has a cross-section including:
a hollow, rectangular primary jamb body; and
a hollow, rectangular secondary jamb body extending from an exterior side of the primary jamb body.

13. The door assembly of claim 12, wherein the primary slab body is configured with at least one bump along the first and second sides of the primary door slab body.

14. The door assembly of claim 13, wherein the door jamb member has a mirrored configuration to allow the door to open in the opposite direction.

15. The door assembly of claim 14, wherein the secondary jamb body has a hollow, L-shaped configuration.

16. The door assembly of claim 12, wherein the door jamb member has a slab lip extending in the first direction from the secondary jamb body, the lip having an L-shape with a distal end extending in the exterior direction.

17. The door assembly of claim 12, wherein the door jamb member has a grooved protrusion extending from a first direction of the secondary jamb body.

18. The door assembly of claim 12, wherein the door jamb member has a cross-section further including a first support lip extending in an exterior direction from an exterior side of the primary jamb body, and a second support lip extending in a second direction from a second side of the primary jamb body.

19. The door assembly of claim 12, wherein the door jamb member has a grooved protrusion extending in the first direction from the primary jamb body, configured to accommodate a thin casing.

20. A door assembly comprising a baseboard edge member configured at the bottom of a drywall panel, wherein the baseboard edge member has a cross-section, including:
a baseboard lip extending in an upward direction from the drywall panel; and
a grooved protrusion extending in a downward direction from the drywall panel, configured to fit with a complimentary groove in a baseboard member.
